(19) United States
(12) Patent Application Publication
(10) Pub. No.: US 2005/0171894 A1
(43) Pub. Date: Aug. 4, 2005

(54) Exchange traded currency fund instrument and system

(76) Inventor: Michael Traynor, Downingtown, PA (US)

Correspondence Address: Gregory J. Lavorgna;DRINKER BIDDLE & REATH LLP, One Logan Square, 18th & Cherry Streets, Philadelphia, PA, 19103-6996, US

(21) Appl. No.: 10/926,614

(22) Filed: Aug. 26, 2004

Related U.S. Application Data
(60) Provisional application No. 60/497,762, filed on Aug. 26, 2003.

(51) Int. Cl. G06F 17/60

(52) U.S. Cl. 705/37; 705/42; 705/43

(57) ABSTRACT

The herein described system and methods encompass a tradable (e.g., exchange-listed) instrument that represents an interest in a fund asset (e.g., an underlying currency). In an illustrative implementation, the interest in the fund asset can be purchased (or sold) against units of another currency and can function as a tradable instrument (e.g., the tradable instrument can reflect the relative value of pairs (or groups) of currencies). In an illustrative practice of the herein described systems and methods, a trust can be formed whose underlying investment can consist of demand deposits denominated in a selected currency (e.g., euros ( [symbol] )). The trust can operate to receive an investment amount in a first currency (e.g., euros) and provide shares (or trust receipts) having a value in a second currency (e.g., U.S. dollars). The shares (or receipts) of the trust can be listed, quoted, and traded on a trading system.

### CROSS REFERENCE AND CLAIM OF PRIORITY

This application cross references and claims priority to U.S. Provisional Application 60/497,762, filed on Aug. 26, 2003, entitled, “EXCHANGE TRADED CURRENCY FUND INSTRUMENT AND SYSTEM,” which is herein incorporated by reference in its entirety.

### FIELD

The herein described systems and methods relate to tradable instruments, and more particularly, to tradable instruments that represent interest in and ownership of a fund asset.

### BACKGROUND

Currency exchange rates represent units of one currency that can be traded, or exchanged, for units of another currency or a basket of currencies. Exchange rate prices are determined by the interaction of buyers and sellers in the foreign exchange (FX) market. The FX market, according to some estimates, is the largest and most liquid market in the world having a daily volume well in excess of $1 trillion U.S. dollars. Foreign exchange trading generally occurs between and among various institutions through over-the-counter (OTC) transactions that are predominantly unregulated. Additionally, a small amount of currency trading activity can occur on organized futures and options exchanges. Currency market participants are wide and varied including but not limited to, commercial and investment banks, governments, corporations, cash managers, mutual funds, hedge funds, pension funds, and private investors. These entities can conduct foreign exchange transactions for a variety of reasons including but not limited to, financing international trade, managing international investment portfolios, and implementing monetary policy.

Currencies can be generally priced in pairs, with one currency traded against another particular currency (or basket of currencies—e.g., all Asian currencies). Each trade can involve the sale of one currency versus the simultaneous buy of another. Currency exchange rates can fluctuate based on a variety of factors, including but not limited to expectations for relative interest rate changes, one or more countries' fiscal policy, import and export activity of one or more countries, and other economic and political factors. The foreign currency trading market currently provides several mechanisms to investors seeking to speculate on or hedge against fluctuations in the relative prices of two given currencies. These instruments include but are not limited to forward contracts, swaps, futures contracts, options contracts, and spot transactions.

Over the Counter (“OTC”) forward and swap contracts can be a mechanism that can be used by institutional and corporate investors to achieve a desired exposure and/or hedge an existing exposure to a particular foreign currency's relative price change or interest rate differential over a given period of time. In practice, the OTC forward and swap contracts can be considered contractual agreements between two parties with agreed-upon terms. Specifically, a forward contract can provide a fixed exchange rate for future delivery on an agreed-upon date by the exchanging parties. Comparatively, a currency swap contract can be used to exchange two currencies on a given date, and can reverse the exchange transaction at a future selected date. Stated differently, a currency swap contract can be equated to a first party borrowing from a second party in a first currency and lending to the second party a loan having an amount in a second currency, with both loans (i.e., first currency borrowed by the first party and second currency borrowed by the second party) being repaid on the same date. OTC currency exchange contracts suffer the drawback of OTC contracts, generally, that is, being exposed to counterparty credit risks.

As described, certain foreign currency futures and options contracts (e.g., standardized futures and options contracts) can be currently transacted on exchanges. In practice, futures contracts can contractually bind the buyer to deliver to the seller a specified unit of currency having a specified price on a specified date. Option contracts, in comparison, can provide a first transacting party with the right, but not the obligation, to deliver to or receive from a second transacting party (or vice versa—second transacting party has the right to deliver to or receive from the first transacting party) a specified unit of currency, for a specified price on or before a specified date. Additionally, OTC foreign currency options can be available directly from private parties. With private OTC foreign currency option transactions comes, in most instances, the use of non-standardized terms. Spot transactions involve the sale of one currency in exchange for another. In practice, the payments surrounding the spot currency transaction can occur between cooperating banks in those countries whose currencies are involved in a given spot currency transaction. As such, spot currency transactions are cumbersome and can be time intensive.

### SUMMARY

The herein described system and methods encompass a tradable (e.g., exchange-listed) instrument that represents an interest in a fund asset (e.g., an underlying currency). In an illustrative implementation, the interest in the fund asset can be purchased (or sold) in units of another currency and can function as a tradable instrument (e.g., the tradable instrument can reflect the relative value of pairs (or groups) of currencies).

In an illustrative practice of the herein described systems and methods, a trust can be formed whose underlying investment can consist of demand deposits (or money market accounts) denominated in a selected currency (e.g., euros ( [symbol] )). The trust can operate to receive an investment amount in a first currency (e.g., euros) and provide shares (or trust receipts) having a value denominated in a second currency (e.g., U.S. dollars). The shares (or receipts) of the trust can be listed, quoted, and traded on a trading system, that among others includes, a U.S. national securities exchange, National Association of Securities Dealers Automated Quote System (NASDAQ), and similar trading system. The price of the shares quoted in a first currency can indicate the current price to buy or sell a second currency (or currencies) against the first currency. Furthermore, the shares can represent an interest in the trust assets that could be interest bearing providing an investment amount to the trust and a return to an investor.

Other aspects and features of the herein described systems and methods are described below.

### BRIEF DESCRIPTION OF THE DRAWINGS

The currency instrument trading system and methods of use are further described with reference to the accompanying drawings in which:

FIG. 1 is a block diagram of an exemplary currency exchange system employing conventional practices;

FIG. 2 is a block diagram of the cooperation between components of an exemplary currency exchange system employing conventional practices;

FIG. 3 is a block diagram of an exemplary currency instrument trading system in accordance with the herein described systems and methods;

FIG. 4 is a block diagram showing the interaction between cooperating components and parties of an exemplary currency instrument trading system in accordance with the herein described systems and methods;

FIG. 5 is a block diagram showing another interaction between cooperating components and parties of an exemplary currency instrument trading system in accordance with the herein described systems and methods;

FIG. 6 is a block diagram showing another interaction between cooperating components and parties of an exemplary currency instrument trading system in accordance with the herein described systems and methods;

FIG. 7 is a flow diagram showing the processing performed by an exemplary currency instrument trading system in accordance with the herein described systems and methods;

FIG. 8 is a flow diagram showing the other processing performed by an exemplary currency instrument trading system in accordance with the herein described systems and methods;

FIG. 9 is a block diagram of an exemplary networked computing environment in accordance with the herein described systems and methods; and

FIG. 10 is a block diagram showing the cooperation of components of an exemplary computing environment in accordance with the herein described systems and methods.

### DETAILED DESCRIPTION

Overview:

There are a number of mechanisms available to exchange currency. From simple currency spot transactions between a buyer and seller in a currency market, to private currency transactions, to non-standardized OTC currency transactions, to regulated and standardized exchange transactions in currency futures and options, these current practices are effective at allowing participating parties to buy and sell currency. However, these practices have many drawbacks that include but are not limited to unreliability, time consuming, risk-intensive, unregulated, and inflexible.

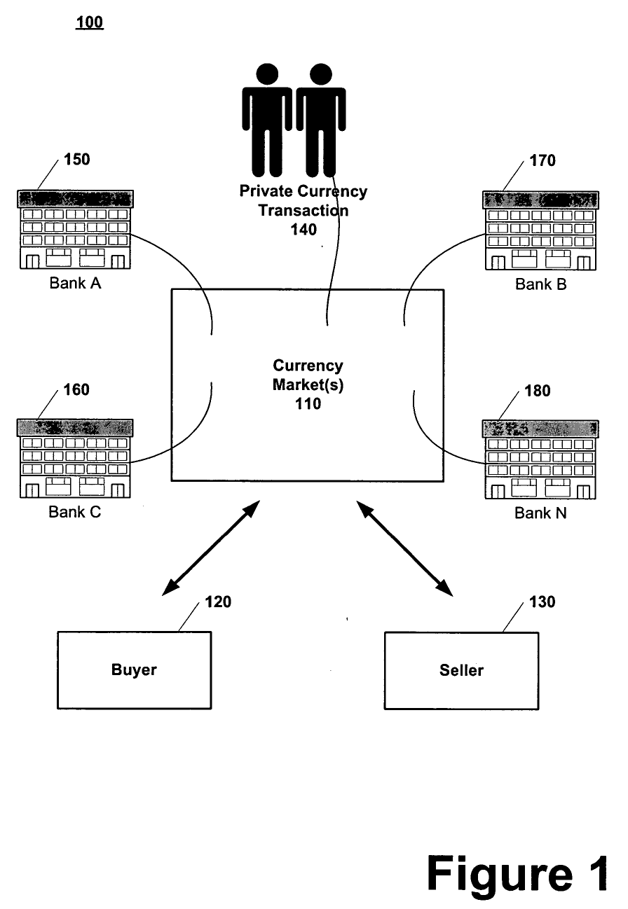

FIG. 1 shows an exemplary currency system 100 wherein currency transactions can be performed according to the above-described practices. As is shown currency system 100 can comprise a currency market (or markets) 110 in which participating banks, such as Bank A 150, Bank B 170, Bank C 160, up to Bank N 180 can exchange currencies. Additionally, as is shown a buyer 120 can use the currency market (or markets) 110 to purchase a desired currency from participating seller 130. Lastly, currency system 100 describes that currency market (or markets) 110 may be employed to provide information or guidance of currency prices for one or more private currency transactions 140.

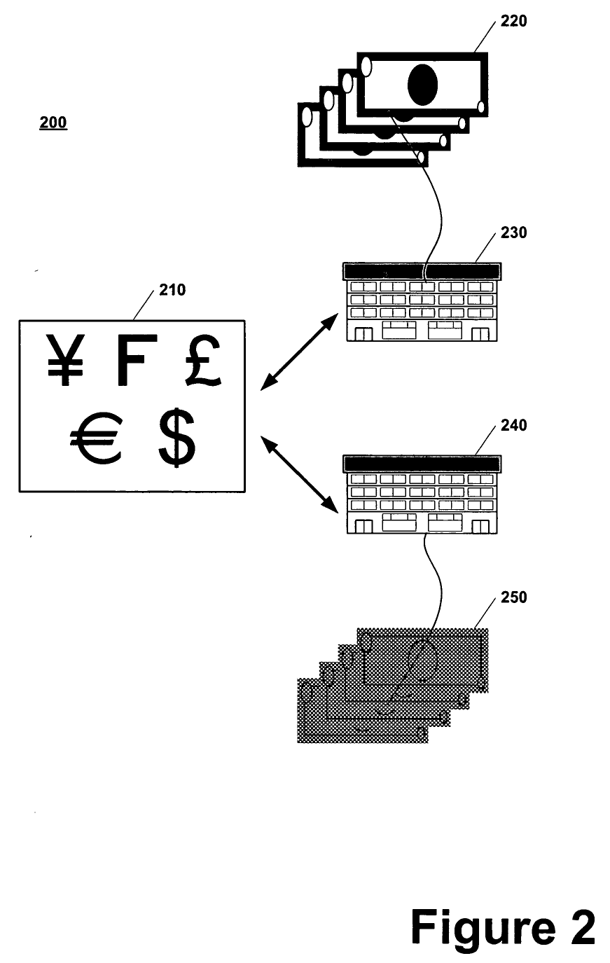

Similarly FIG. 2 shows the cooperation between participating banks in a spot currency transaction 200. As is shown bank 230 having a first currency 220 can seek to exchange the first currency 220 in currency market 210 for one more other currencies (not shown). Similarly bank 240 having one or more of the other currencies 250 can use currency market 210 to exchange its one or more other currency 250 with a first currency 220. In this context, the currency market 210 sets the price for each of the currencies based on a number of factors that include but are not limited to the supply and demand for each of the currencies being exchanged through the currency market 210.

From the foregoing it is appreciated that the above-described practices do not use an instrument that securitizes a currency (or currencies). Such instrument could be made available to investors (i.e., available through a brokerage account) such that the instrument acts as a proxy for over-the-counter (OTC) foreign exchange spot transactions. Additionally, the instrument could serve to facilitate the buying and selling of one currency against the other when certain currencies become difficult to obtain.

The herein described system and methods aim to ameliorate the shortcomings of existing practices by providing an exchange tradable instrument that securitizes one currency (or a multiple of currencies) against another currency (or a set of other currencies or currency index). In an illustrative implementation, the herein described systems and methods provide a tradable instrument that can represent an ownership of an interest in a fund asset. The fund asset can represent at least one first (or first set of currencies or a first currency index(es)) currency having a value denominated in a second currency (or second set of currencies or second currency index(es)). Additionally, the tradable instrument can represent the relative value of at least one first currency and at least one second currency. In the implementation provided, it can be that one of the currencies of the first or second sets (or indexes of currencies) is United States dollars.

Furthermore, in an illustrative implementation, the herein described systems and methods can provide an instrument issued by a statutory trust that represents an undivided beneficial interest in a portfolio having at least one first currency. The portfolio can have a market value denominated in at least one second currency. Such value (denominated in at least one second currency) can fluctuate in response to changes in relative value of the underlying first currency. In the implementation provided, the instrument can be tradable on a trading system and can be purchased and redeemed through the trust. Additionally, the assets of the trust (e.g., at least one currency bearing an interest rate at prevailing market rates) can be held by a custodian for the benefit of trust investors. In the implementation provided, it can be that either the first or second currency is United States dollars.

In another illustrative implementation, the herein described systems and methods provide a trading system having a fund held by a custodian. The fund can maintain at least one first currency that is invested by the fund according to selected parameters to realize market rates of return (e.g., the fund being managed by a custodian placing the assets of the fund into interest-bearing deposit or money market accounts with one or multiple banking institutions). In this illustrative implementation, the fund provides a tradable instrument that can represent ownership of an interest in the fund. The tradable instrument can have a value denominated in a second currency and can be representative of the relative values of said at least one first currency and the second currency. The tradable instrument can be issued to an investor in exchange for an investment amount and redeemable by the investor for their investment amount. In this context, the custodian can cooperate with the trustee of a trust to issue trust receipts to investors in exchange for a deposit by an investor of the at least one first currency. The custodian can also act to redeem trust receipts and deliver to the investor a value representative of the investor's deposit (i.e., the investor's interest in the trust's portfolio consisting of the at least one first currency in exchange for the redeemed trust receipts). The trust receipts can be tradable on the trading system. In this implementation, the trust currency can be a non-U.S. currency.

Tradable Currency Instrument:

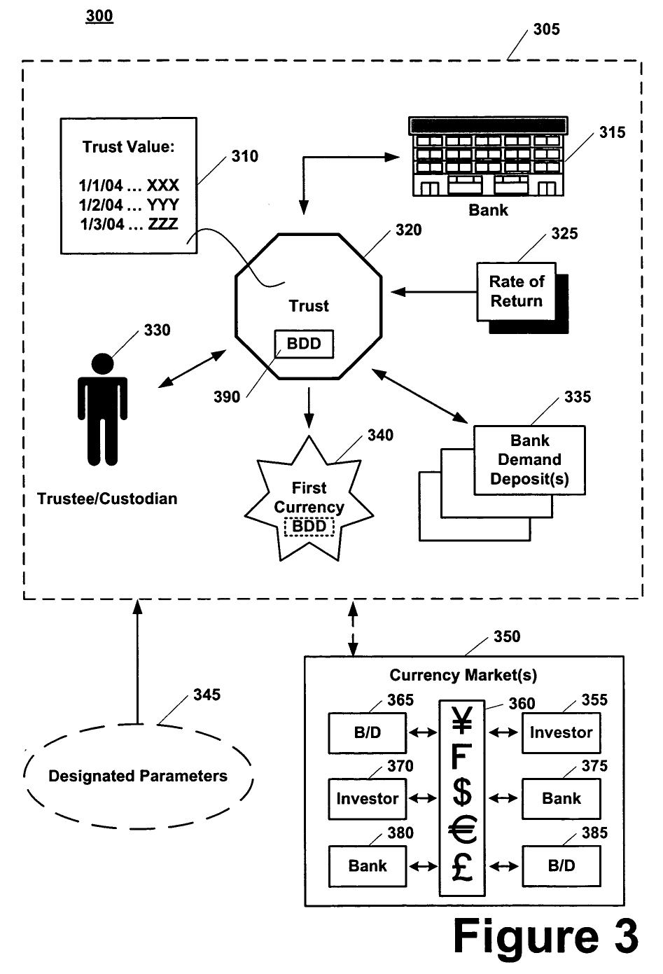

FIG. 3 shows a block diagram of an illustrative currency trading system 305 operating in currency trading environment 300. As is shown, currency trading environment 300 comprises illustrative currency trading system 305, designated parameters 345, and currency market(s) 350. Further, as is shown, illustrative currency trading system 305 comprises trust 320 having a trustee/custodian 330 and interfacing with bank 315. Additionally, trust 320 operates to have trust value 310 and generates a rate of return 325. As is shown, currency market(s) 350 comprise a number of cooperating parties that include but are not limited to broker/dealer (B/D) 365 and 385, banks 375 and 380, and investors 355 and 370. In operation within currency market(s) 350, the cooperating parties cooperate to exchange currency(ies) 360. Currency market(s) 350 can act as a source of information for investor(s) (not shown) to assist them with their currency-type investments (as shown by the broken arrow).

In operation, statutory trust 320 can be initially established as a custodial arrangement with bank 315 of currency trading system 305, whereby a beneficial owner of an interest in the trust (not shown) is considered a beneficial owner of an interest in the underlying investment, for example, bank demand deposits 390, held by trust 320. The demand deposits 390 can be denominated in a first currency or currencies, including but not limited to an index and basket of different currencies (e.g., a basket of each of the currencies of a region, such as Asia) (not shown). The demand deposits can also earn market rates of return 325, which can be credited to trust 320 at regular intervals. In a contemplated illustrative operation, the operating expenses of trust 320 can be paid out rates of return 325.

Additionally, trustee 330 of trust 320 can enter into an agreement with the trust 320 to invest the trust assets (not shown). However, the trustee 330 can operate not to have discretion regarding the management of the trust's investments (e.g., demand deposits 390) so to preserve certain tax and business organization advantages. Stated differently, the account(s) (now shown) and banks in which the trust's 320 foreign currency deposits (not shown) can be held can be determined in advance and have designated parameters 345 by which additional accounts and banks are used and interest earnings accrue and are paid to trust 320.

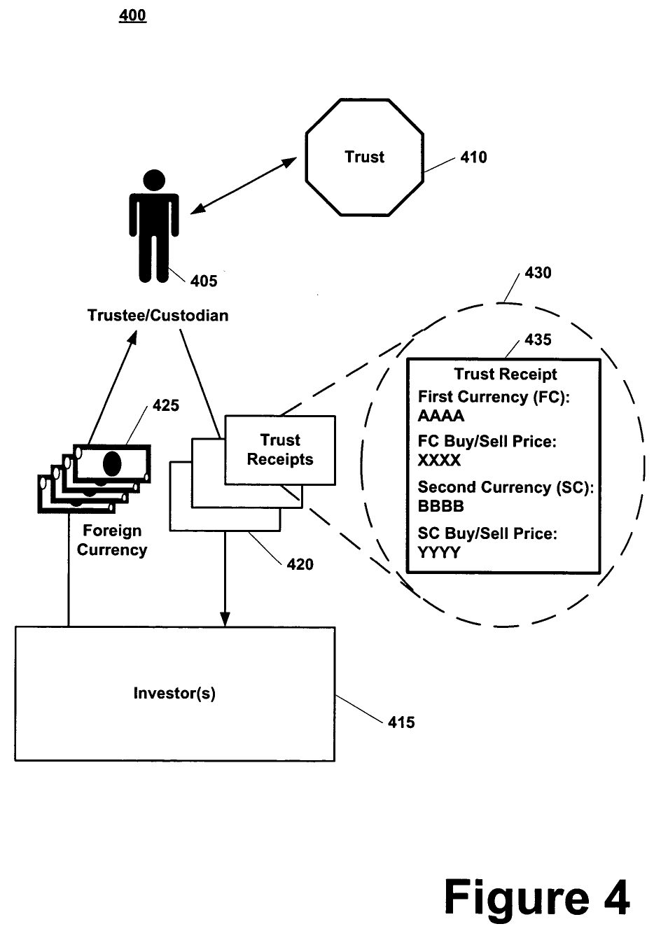

FIG. 4 shows another illustrative implementation of an illustrative currency trading system 400. As is shown, illustrative currency trading system 400 comprises trust 410 represented by a trustee/custodian 405. Trustee/custodian 405 cooperates with investor(s) 415 to received currency 425 and issue trust receipts 420 representative of an ownership interest (not shown) in the assets (not shown) of trust 410. Trust receipts 420, as is shown in exploded view 430, can comprise a physical receipt 435 having information about the trust investment, currency type and trust receipt value (generally shown).

In operation, trustee 405 can perform the task of receiving and disbursing foreign currency 425 in exchange for a specified number of trust receipts 420. Each receipt, or share, can reflect the price to buy or sell a first currency(ies), in second currency terms (as is shown in trust receipt 435). In the illustrative implementation, trust 410 can receive an investment amount in the form a first currency 425. The trustee (or custodian) 405 can issue trust shares (or receipts) 420 such that each share can be referred to as the “first currency” share and each share can be purchased by investing the first currency 425 (while having a value denominated in a second currency).

In an illustrative implementation, if the first currency is Japanese Yen, trustee 405 can issue “Yen Trust Shares” (or “Receipts”) 420 such that 10,000 Yen can purchase one “Yen Trust Share” (or “Receipt”) having a value in U.S. dollars (e.g., given a Japanese Yen to U.S. Dollar conversion rate of 110 Yen to 1 U.S. Dollar, a “Yen Trust Share” (or “Receipt”) can be purchased for 10,000 Yen and can have a value of 90.90 U.S. Dollars). In the implementation, given investor(s) 415 invest 1,000,000 Yen with trustee (or custodian) 405 of trust 410, and a “Yen Trust Share” (or “Receipt”) can be purchased for 10,000 Yen per share, trustee (or custodian) 405 can issue 100 “Yen Trust Shares” (or “Receipts”) 420 to investor(s) 415. Trustee (or custodian) 405, according to designated parameters, can place the 1,000,000 Yen received from investor(s) into deposit account(s) (not shown) that can earn a rate of return.

At some subsequent time, investor(s) 415 can request their investment amount 425 back in exchange for giving back to the trustee their issued “Yen Trust Shares” (or “Receipts”) 420 (i.e., liquidation of “Yen Trust Shares” (or “Receipts”)). In such case, trustee (or custodian) 405 can liquidate the deposit account(s) (not shown) that contain the initially invested 1,000,000 Yen and can deliver the 1,000,000 Yen (plus any returns that may have accrued on the 1,000,000 Yen while sitting in the deposit accounts) to the investor requesting the liquidation of their “Yen Trust Shares” (or “Receipts”) 420.

The trust agreement can be structured, in an another illustrative implementation, such that trustee 405 can agree to deliver to investor 415 one hundred (100) shares of a U.S. listed euro receipt (not shown) in return for a deposit of [symbol] 10,000 (not shown). In the implementation provided, and for purposes of describing the herein described system and methods, it is assumed that spot currency exchange rates are [symbol] 1.10 per dollar (e.g., $0.9091 per euro). As such, the price of euro receipt shares would trade very close to the value of $90.91, since trust 405 can accept delivery of [symbol] 10,000 in return for 100 euro receipt shares (i.e., [symbol] 10,000 would in this example be worth $9,091). Arbitrage opportunities can result from relative movement of exchange rates absent corresponding movement in the price of the euro receipt shares. In some instances, such opportunities can be captured by coupling a foreign exchange (FX) trade with the creation or redemption of receipts and can ensure that the quoted U.S. dollar share price will move in tandem with spot exchange rate quotations.

For purposes of illustration, in the above provided illustrative implementation, if the dollar strengthened to [symbol] 1.15 per dollar (i.e., $0.8695 per euro) while the euro receipt share remained at $90.91 (i.e., [symbol] 10,000/100 share= [symbol] 100/share=$90.91/share), then investors could
1. Convert $8,695 into [symbol] 10,000 in an FX trade.
2. Deliver [symbol] 10,000 to trustee 405 in exchange for 100 euro shares (or trust receipts).
3. Sell 100 euro shares (or trust receipts) for $9,091 on an exchange (e.g., NYSE, NASDAQ, AMEX, etc.).
4. Retain $396 as profit ($9,091-$8,695) (e.g., exclusive of transaction costs).

In the above implementation, a U.S. listed trust share (or trust receipt) can function as a proxy for the relative value of one U.S. dollar per unit of foreign currency(ies). In this context, investors who “long” the trust shares (or trust receipts) can synthetically “short” the U.S. dollar vs. the foreign currency(ies) (or “long” the foreign currency(ies) vs. the dollar). Investors who “short” the trust shares (or trust receipts) can synthetically “long” the U.S. dollar vs. the foreign currency(ies) (or “short” the foreign currency(ies) vs. the dollar). An owner of a trust share (or trust receipt) can have an economic interest similar to that of an investment in a non-U.S. currency(ies) through a tradable instrument (e.g., trust share (or trust receipt)). In operation, a trust share (or trust receipt) can reflect the price of a particular foreign currency(ies) in U.S. dollars. As such, the trust share (or trust receipt) can act to “securitize” spot foreign exchange transactions which can be transacted in a standardized format and regulated environment(s).

In the implementations provided herein, the exemplary trust can act as an “open-ended” fund that can receive specified additional investments at any time, in exchange for the issuance of new trust shares (or trust receipts), instead of being limited to a specific number of trust shares (or trust receipts). In being “open-ended,” the exemplary trust provided herein supports continuous arbitrage opportunities that can act to keep the trust share (or trust receipt) price in line with the spot exchange rates. Additionally, the continuous arbitrage opportunities can help to ensure that the trust share (or trust receipt) value does not become a function of supply and demand for a limited number of trust shares. The trust share value, in this context, can be directly related to the spot exchange rate and little else.

Additionally, the potential for price manipulation of shares (or receipts) of the exemplary trust is mitigated by structuring the trust as an “open-ended” exchange-traded fund. The “open-ended” structure operates such that the issuance and cancellation of the underlying fund or trust is open to qualified market participants through clearing broker-dealers. Such ability makes it difficult to manipulate the prices of the trust share (or receipt) with any efficacy. Furthermore, the potential for price manipulation of trust shares (or receipts) of the exemplary trust is further mitigated due to the availability and liquidity of foreign currency future and options contracts and other related instruments that can be used in the arbitrage of price discrepancies.

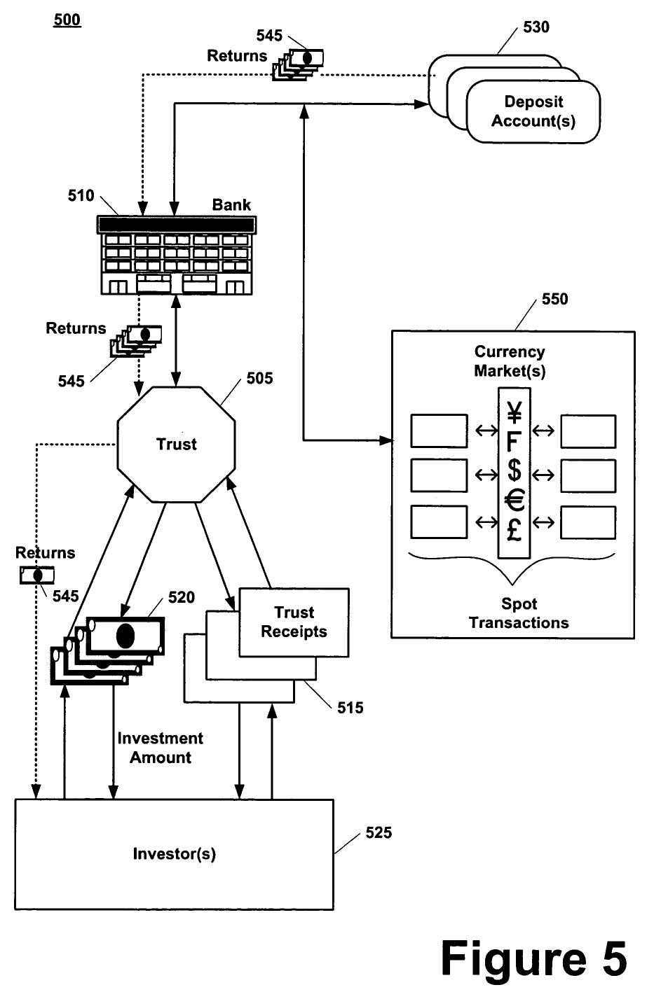

FIG. 5 shows another illustrative implementation of the herein described systems and methods to provide for exemplary currency trading system 500. As is shown currency trading system 500 comprises trust 505 interfacing with bank 510 and investor(s) 525 through a trustee or custodian (not shown). In operation, trust 505 receives investment amounts (in a first currency or set of currencies or currency index or set of currency indexes) from investor 525 and provides trust shares (or trust receipts) 515 having the investment amount (in a second currency or set of currencies or currency index or set of currency indexes). Trust 505 interfaces with bank 510 through a trustee or custodian (not shown) to place the investment amount in deposit accounts 530 (e.g., demand deposit accounts or money market accounts) subject to established parameters (not shown) to generate returns 545.

Further to exemplary currency trading system 500, investor 525, when placing an investment in the trust does not need to complete a spot currency exchange transaction in a currency market 550. Instead, bank 510 (or other intermediary—not shown) can perform the spot currency exchange transaction if so desired by a delivering (or receiving) broker (not shown). The trustee bank 510 can then deliver the requisite currency to a deposit account(s) 530 (e.g., offshore deposit accounts) and realize a return 545. The interest earnings from such deposit accounts 530 can accrue to trust 505, whose beneficial owners are the holders of the trust shares (or trust receipts) (e.g., investor(s) 525). In a contemplated illustrative implementation, the trust shareholder can at selected times be permitted to tender the trust shares (or trust receipts) in exchange for a fixed amount of the currency(ies).

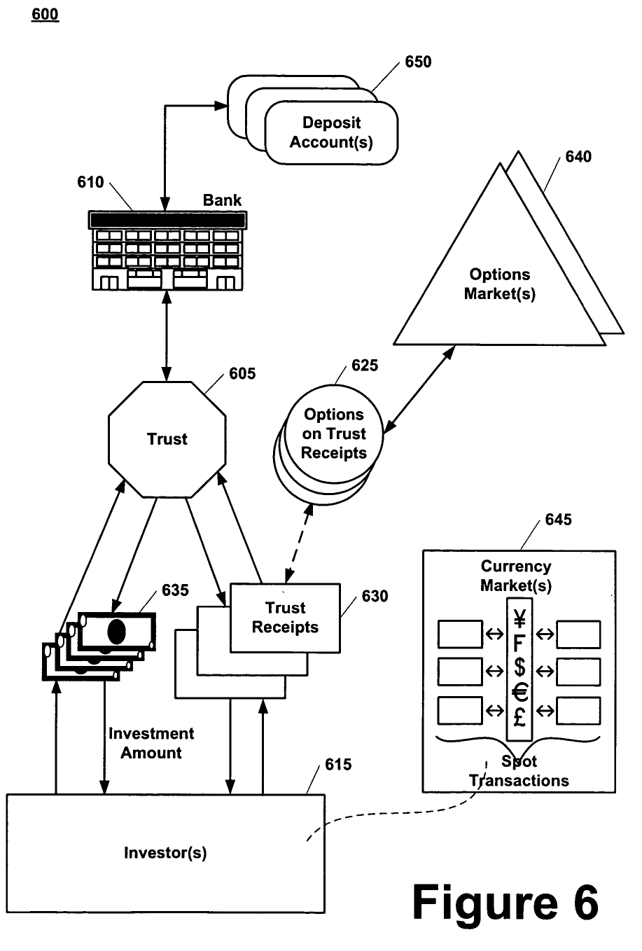

FIG. 6 shows another illustrative implementation of the herein described systems and methods that provide exemplary currency trading system 600. As is shown in FIG. 6, exemplary currency trading system 600 comprises trust 605 having trust shares (or trust receipts) 630 and interfacing through a trustee or custodian (not shown) with bank 610 and with investor(s) 615 through investment amount 635 and trust receipts 630. Exemplary currency trading system 600 further comprises options 625 on trust shares (or trust receipts) 630 and option market(s) 640. Currency market(s) 645 can be employed by investor(s) 615 to obtain information about currency prices.

In operation, investor(s) 615 provide to trust 605 an investment amount 635 (in a first currency or set of currencies or currency index or set of currency indexes) which trust 605 through a trustee or custodian (not shown) deposits with bank 610 in deposit accounts 650 (or money market accounts—not shown). In return for investment amount 635, trust 605 issues trust shares (or trust receipts) 630 (denominated in a second currency or set of currencies or currency index or set of currency indexes) to investor(s) 615. Options 625 can be associated with trust receipts (or trust shares) 630 (as shown by the broken arrow) and can be used by investor(s) 615 on options market(s) (e.g., option exchange) 640 to provide more flexibility in the application of various trading strategies.

It is appreciated that the illustrative implementations described herein are merely descriptive and do not limit the inventive concepts of the herein described systems and methods to any particular system configuration having selected components. Rather, the inventive concepts described herein can extend to various configurations and components. For example, the exemplary trusts described herein, need not be limited to a single currency. It is within the scope of the inventive concepts to create a trust receipt based on a “basket” of currencies against a single currency, where the basket would contain fixed amounts of multiple currencies, weighted by a selected weighting mechanism that results in a good proxy for the intended benchmark of currencies. As such, investors are afforded a currency exchange practice that allows a view on the value of a single currency against groups of currencies.

By way of example, the herein described systems and methods are described. Given a U.S. investor has bought stocks domiciled in the Eurozone, either directly or through a pooled account or fund. Under conventional practices, the currency risk (euro/dollar) is not hedged out separately, and that investor assumes stock specific risk along with currency risk. Therefore, if the stocks appreciate by 10% but the euro weakens against the dollar by 10%, then the investor's return is approximately 0%. With the herein described systems and methods, the investor could “short” a euro trust share, effectively reversing the currency trade realized at the time the stocks were purchased.

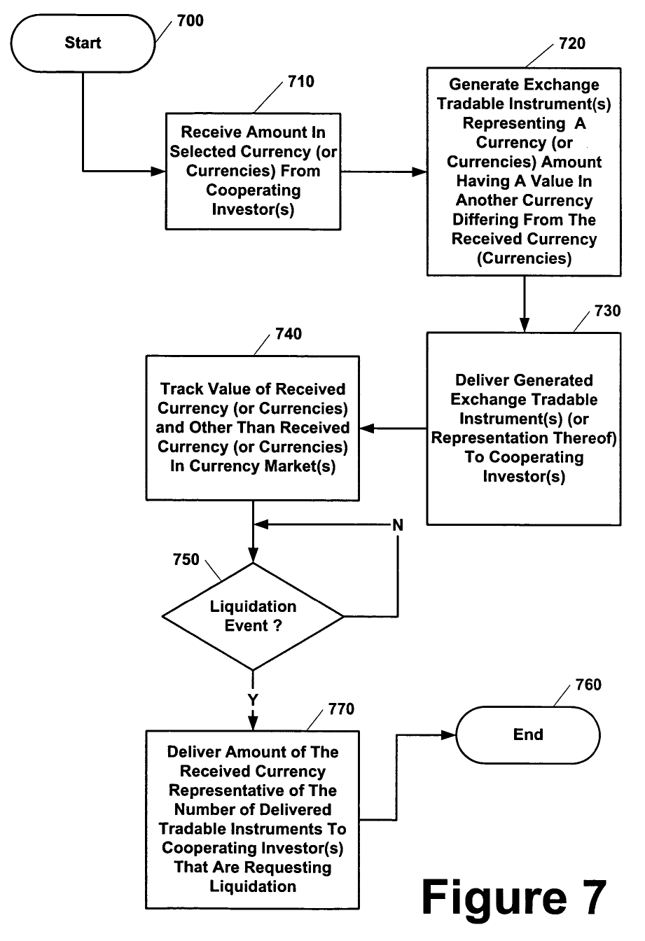

FIG. 7 shows the processing performed when handling tradable currency instruments. As is shown in FIG. 7, processing begins at block 700 and proceeds to block 710 where an amount in a selected currency (or set of currencies) is received by a trust (or fund) from cooperating investor(s). Processing then proceeds to block 720 where exchange tradable instruments representing the received currency (or currencies) amount having a value in another currency (or currencies) differing from the received currency (or currencies) are generated. The generated exchange tradable instrument(s) (or representations thereof) are delivered to the cooperating investor(s) at block 730. Form there, the value of the received currency (or currencies) and other than received currency (or currencies) are tracked in currency market(s) at block 740. A check is then performed at block 750 to determine if an investor has requested a liquidation of the exchange tradable instrument. If there is no liquidation at block 750, processing reverts to the input of block 750.

However if at block 750, it is determined that there is requested liquidation event, processing proceeds to block 770 where an amount of the received currency representative of the number of delivered tradable instruments is provided to the investor(s) requesting the liquidation. Processing then terminates at block 760.

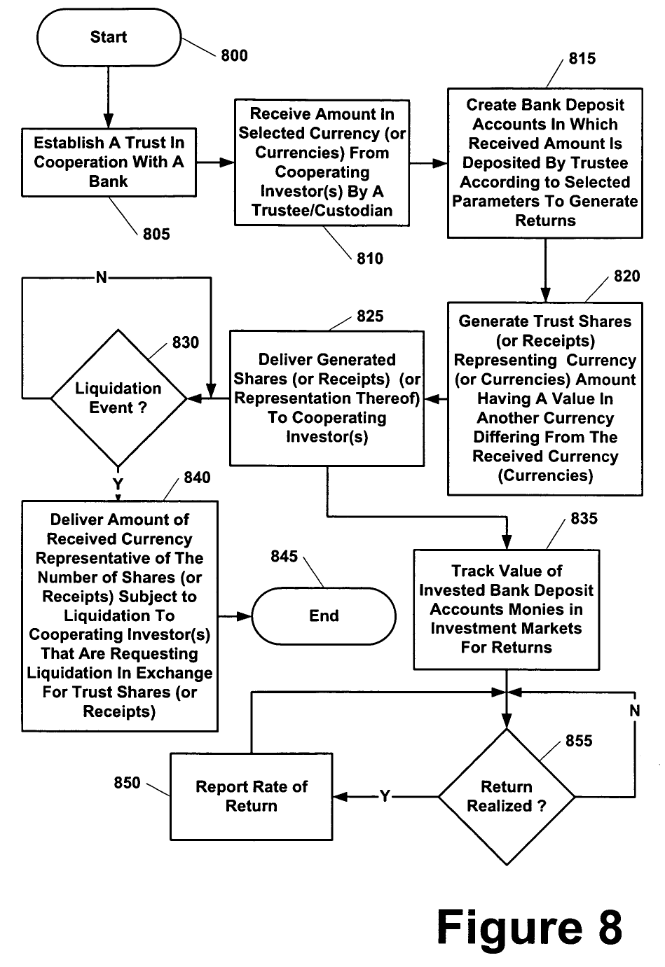

FIG. 8 shows the processing performed by another illustrative implementation having a currency trading system when handling tradable currency instruments. As is shown, processing begins at block 800 and proceeds to block 805 where a trust is established in cooperation with a bank. Processing proceeds to block 810 where an amount in a first selected currency (or currencies) is received from a cooperating investor(s) by a trustee/custodian. From there processing proceeds to block 815 where the trust's trustee or custodian deposits the received amounts in deposit accounts according to selected parameters to generate returns. Trust shares (or receipts) are then generated at block 820 for delivery to cooperating investor(s). The trust shares (or receipts) can have a value in another currency (or currencies) than the received amount currency (or currencies). The generated trust shares (or receipts) (or a representation thereof) are delivered to the cooperating investor(s) at block 825. From block 825, the processing can fork and proceed to block 830 or block 835.

At block 835 the value of the invested bank deposit account monies are tracked to determine if there are any returns. A check is then performed at block 855 to determine if there is a return. If a return has been realized, processing proceeds to block 850 where the return is reported to the trust and can, in turn, be reported from the trust to the investor(s). From there processing reverts back to block 855 and proceeds from there. However, if at block 855 it is determined that there are not returns realized, processing reverts to the input block 855 and proceeds from there.

At block 830 a check is performed to determine if a liquidation event has been requested by one or more of the cooperating investors having trust shares (or receipts). If a liquidation event has been requested, processing proceeds to block 840 where an amount of the received currency representative of the number of trust shares (or receipts) is delivered to cooperating investor(s) requesting the liquidation in exchange for such trust shares (or trust receipts). Processing then terminates at block 845. If, however, at block 830 it is determined that a liquidation event has not been requested, processing reverts to the input of block 830 and proceeds from there.

Exemplary Networked Computing Environment:

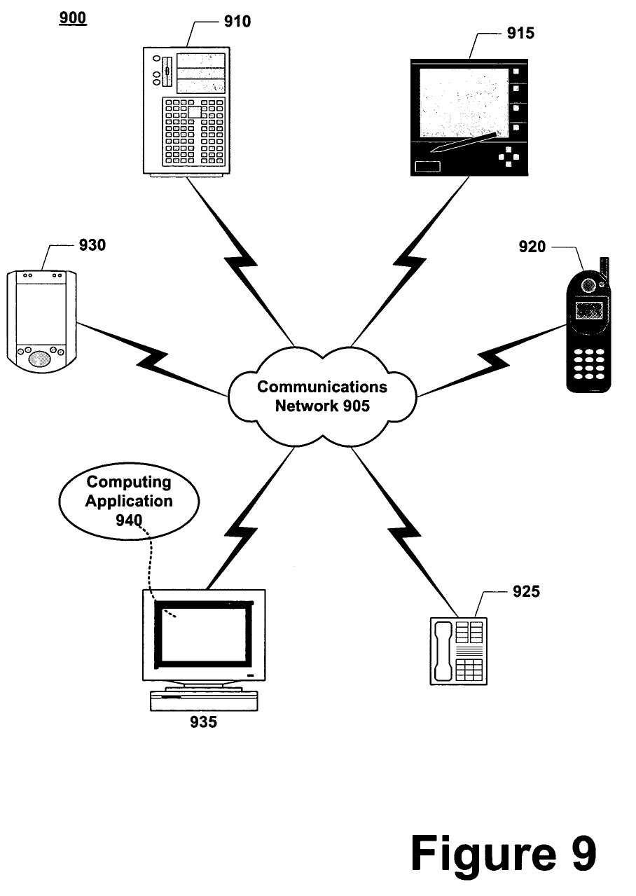

The herein described systems and methods may be deployed in a computing environment 900. In general, the following description for computing environments applies to both server computers and client computers deployed in a network environment. FIG. 9 illustrates an exemplary illustrative networked computing environment 900, with a server in communication with client computers via a communications network, in which the herein described apparatus and methods may be employed. As shown in FIG. 9 server 910 can be interconnected via a communications network 905 (which may be either of, or a combination of a fixed-wire or wireless LAN, WAN, intranet, extranet, peer-to-peer network, the Internet, or other communications network) with a number of client computing environments such as tablet personal computer 915, mobile telephone 920, telephone 925, personal computer 935, and personal digital assistance 930. In a network environment in which the communications network 905 is the Internet or financial communication networks such as FIXX, for example, server 910 can be dedicated computing environment servers operable to process and communicate computing instructions to and from client computing environments 910, 915, 920, 925, 930, and 935 via any of a number of known protocols, such as, hypertext transfer protocol (HTTP), file transfer protocol (FTP), simple object access protocol (SOAP), or wireless application protocol (WAP). Each client computing environment 910, 915, 920, 925, 930, and 935 can be equipped with computing application 940 operable to support one or more computing applications such as a web browser (not shown) to gain access to server computing environment 910.

In operation, a user (not shown) may interact with a computing application running on a client computing environments to obtain desired data and/or computing applications. The data and/or computing applications may be stored on server computing environment 910 and communicated to cooperating users through client computing environments 910, 915, 920, 925, 930, and 935, over exemplary communications network 905. A participating user may request access to specific data and applications housed in whole or in part on server computing environment 900 using web services transactions or other computing instructions protocols. These web services transactions or other computing instructions protocols may be communicated between client computing environments 910, 915, 920, 925, 930, and 935 and server computing environment 910 for processing and storage. Server computing environment 915 may host computing applications, processes and applets for the generation, authentication, encryption, and communication of currency transaction and may cooperate with other server computing environments (not shown), third party service providers (not shown), network attached storage (NAS) and storage area networks (SAN) to realize such currency transactions.

Thus, the systems and methods described herein can be utilized in a computer network environment having client computing environments for accessing and interacting with the network and a server computing environment for interacting with client computing environments. However, the systems and methods providing the tradable currency instrument system and methods can be implemented with a variety of network-based architectures, and thus should not be limited to the example shown.

Currency Trading System Components:

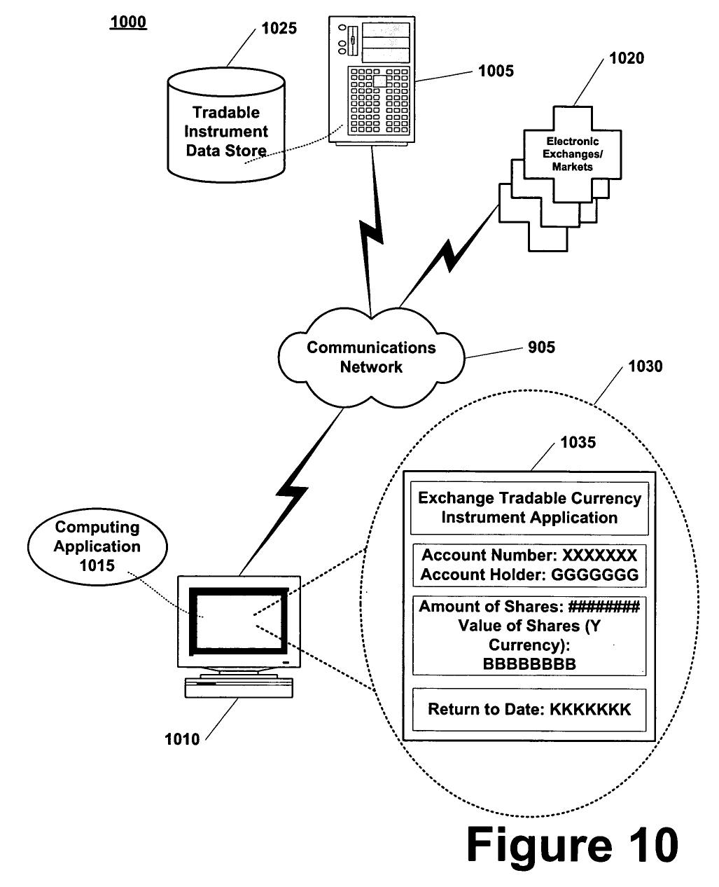

FIG. 10 shows an exemplary interaction between an exemplary tradable currency instrument trading system 1005 and a client computing device 1010 having a computing application 1015 operable to perform one or more operations or processes described above. Generally as is shown in FIG. 10, exemplary tradable currency instrument platform 1000, in simple terms, may comprise tradable currency instrument trading system 1005 cooperating with client computing environment 1010 using communications network 905 (of FIG. 9) operating on a selected communications protocol (not shown). Additionally, exemplary tradable currency instrument platform 1000 may further comprise electronic exchanges/markets 1020 communicatively operable to both exemplary tradable currency instrument trading system 1005 and client computing environment 1010 through communications network 905 (of FIG. 9).

In operation, client computing environment 1010 having computing application 1015 may cooperate with tradable currency instrument trading system 1005 through communications network 905 to execute instructions for computing application 1015 indicative of one or more operations and/or processes surrounding the generation, management, and trading of tradable currency instruments. Computing application 1015 is operable to be displayable for user interaction on client computing environment 1010. In the context of trading, exemplary tradable currency instrument trading system 1005 may cooperate with electronic exchanges/markets 1020 to realize one or more trades of on or more tradable currency instruments. Furthermore, exemplary tradable currency instrument trading system 1005 can comprise tradable instrument data store 1025 which can be used to store and retrieve information about generated and managed tradable currency instruments.

As is shown in FIG. 10, computing application 1015 is shown in an enlarged perspective 1030. Computing application enlarged perspective 1030 comprises computing application interface 1035 containing various data representative of a tradable currency instrument and its uses. In an illustrative implementation, the computing application 1015 data can comprise account number information representative of an investor account for use in obtaining, managing, and trading tradable currency instruments (not shown), account holder information, amount of tradable instruments in the account, the value of the tradable instruments in the purchased currency (or currencies) amount and the value of the tradable instrument in the desired currency (or currencies) amount. It is appreciated that this list is in no way meant to be inclusive as the inventive concepts described herein can require numerous other data to be processed, stored, and displayed by computing application 1015.

In sum, the herein described systems and methods provide tradable currency instrument. It is understood, however, that the invention is susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments (including both non-wireless and wireless computer environments), partial computing environments, and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the herein described systems and methods have been described in detail above, those skilled in the art will readily appreciate that many additional modifications are possible in the illustrative implementations and exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

1. A tradable instrument representing ownership of an interest in a fund asset,
wherein the fund asset has a value represented in at least one first currency, and
wherein the fund asset has a value denominated in a second currency different from the first currency, and
wherein the fund asset has a value representative of the relative values of the at least one first currency and the second currency.

2. The tradable instrument as recited in claim 1, wherein the first currency is a non-U.S. currency and the second currency is U.S. dollars.

3. The tradable instrument as recited in claim 1, wherein the at least one first currency comprises a plurality of different currencies.

4. The tradable instrument as recited in claim 1, wherein the at least one first currency comprises any of a currency index and a basket of currencies.

5. A tradable instrument representing ownership of an interest in a fund asset,
wherein the fund asset represents at least one non-U.S. currency, and
wherein the fund asset has a value denominated in U.S. dollars, and
wherein the fund asset has a value representative of the relative values of such non-U.S. currency and the U.S. dollar.

6. An instrument issued by a statutory trust comprising a trust share that represents an undivided beneficial interest in a portfolio of at least one first currency with a market value denominated in a second currency different from the at least one first currency that fluctuates in response to changes in value of the underlying at least one first currency.

7. The instrument as recited in claim 6 wherein the trust share is capable of being traded on a trading system and able to be purchased and redeemed through the trust.

8. The instrument as recited in claim 6, wherein the first currency is a non-U.S. currency and the second currency is U.S. dollars.

9. An instrument issued by a statutory trust comprising a trust receipt that represents an undivided beneficial interest in a portfolio of at least one first currency with a market value denominated in a second currency different from the at least one first currency that fluctuates in response to changes in value of the underlying at least one first currency.

10. The instrument as recited in claim 9 wherein the share is capable of being traded on a trading system and able to be purchased and redeemed through the trust.

11. The instrument of claim 9, wherein the first currency is a non-U.S. currency and the second currency is U.S. dollars.

12. An instrument issued by a statutory trust comprising a trust share that represents an undivided beneficial interest in a portfolio of at least one non-U.S. currency with a market value denominated in U.S. currency that will fluctuate in response to changes in value of the underlying non-U.S. currency, the instrument being tradable on a trading system.

13. The instrument as recited in claim 12 wherein the trust share is capable of being purchased and redeemed through the trust.

14. An instrument issued by a statutory trust comprising a trust receipt that represents an undivided beneficial interest in a portfolio of at least one non-U.S. currency with a market value denominated in U.S. currency that will fluctuate in response to changes in value of the underlying non-U.S. currency, the instrument being tradable on a trading system.

15. The instrument as recited in claim 12 wherein the trust receipt is capable of being purchased and redeemed through the trust.

16. A trading system, comprising:
a fund held by a custodian and consisting of at least one first currency; and
a tradable instrument representing ownership of an interest in the fund and having a value denominated in a second currency different from the at least one first currency and representative of the relative values of said at least one first currency and the second currency, the instrument being issued to an investor in exchange for an investment amount.

17. The trading system as recited in claim 16 wherein the at least one first currency is invested in interest bearing accounts providing for a market rate of return.

18. The trading system as recited in claim 16, wherein the at least one first currency is a non-U.S. currency and the second currency is U.S. dollars.

19. The trading system as recited in claim 18, wherein the first currency is a plurality of different currencies.

20. A trading system, comprising
a fund held by a custodian and consisting of at least one non-U.S. currency and invested at market rates of return, and
a tradable instrument representing ownership of an interest in the fund and having a value denominated in U.S. dollars and representative of the relative values of at least one non-U.S. currency and the U.S. dollar, the instrument being issued to an investor in exchange for an investment amount.

21. The trading system as recited in claim 20, wherein the investment amount is the second currency.

22. A trading system, comprising:
a statutory trust, the assets of which consist of at least one first currency bearing interest at market rates of return and held by a custodian for the benefit of investors; and
an instrument issued by the trust representing an undivided beneficial interest in the trust assets, the instrument having a value denominated in a second currency different from the first currency and being tradable on a stock exchange and similar trading systems.

23. The system as recited in claim 22 wherein the instrument is capable of being purchased and redeemed through the trust.

24. The trading system as recited in claim 23, wherein the at least one first currency is a non-U.S. currency and the second currency is U.S. dollars.

25. The trading system as recited in claim 23, wherein the at least one first currency is a plurality of different currencies.

26. A trading system, comprising:
a statutory trust, the assets of which consist of at least one non-U.S. currency bearing a return and held by a custodian for the benefit of investors; and
an instrument issued by the trust representing an undivided beneficial interest in the trust assets, the instrument having a value denominated in U.S. currency and being tradable on a stock exchange and similar trading systems.

27. The trading system as recited in claim 26 wherein the instrument is capable of being purchased and redeemed through the trust.

28. A method of investing, comprising
accepting from an investor an investment amount in at least one first currency;
establishing a fund with a custodian;
investing said at least one first currency in assets denominated in said at least one first currency that bears a return; and
issuing to said investor a tradable instrument representing ownership of an interest in the fund and having a value denominated in a second currency different from the first currency and representative of the relative values of said at least one first currency or currencies and the second currency.

29. The method as recited in claim 28, wherein the assets comprise any of demand deposits and money market accounts.

30. The method as recited in claim 28, wherein the first currency is U.S. dollars and the second currency is at least one non-U.S. currency.

31. The method as recited in claim 30, wherein the at least one non-U.S. currency comprises a plurality of different currencies.

32. The method as recited in claim 30, wherein the at least one non-U.S. currency comprises a currency index.

33. The method as recited in claim 28, further comprising facilitating the ability to buy and/or sell options on the tradable instrument through an options trading system.

34. A method of investing, comprising
accepting from an investor an investment amount in at least one first currency,
establishing a monetary fund; and
issuing to said investor a tradable instrument representing ownership of an interest in the fund and having a value denominated in a second currency different from the at least one first currency and representative of the relative values of said at least one first currency and the second currency.

35. The method as recited claim 34, further comprising facilitating the ability to buy and/or sell options on the tradable instrument through an options trading system.

36. The method as recited in claim 34 further comprising investing said at least one first currency to generate a return.

37. A method of investing comprising:
establishing a financial construct comprising any of a monetary fund and a trust the assets of which are held by a custodian for the benefit of investors;
entering into an agreement with the custodian that directs the custodian to invest the assets of the financial construct according to at least one designated parameter, comprising any of investing in an account comprising any of interest-bearing deposit and money market accounts with multiple banking institutions and to issue a representation of an ownership interest in the financial construct comprising any of a share and receipt to investors in exchange for the deposit by an investor of at least one currency with the trustee of the trust; and
redeeming representation of the ownership interest in the financial construct; and
delivering currency in exchange for the representation of the ownership interest in the financial construct redeemed, the representation of the ownership interest in the financial construct being tradable on a trading system.
